(19) United States
(12) Patent Application Publication
(10) Pub. No.: US 2012/0284154 A1
(43) Pub. Date: Nov. 8, 2012

(54) Articles Of Manufacture, Education Billing Management Methods, Education Billing Management Systems, Education Enrollment Systems, And Education Enrollment Methods

(76) Inventors: Jeffrey Creighton, Encinitas, CA (US); Timothy Behrendsen, Ranchos Palos Verde, CA (US)

(21) Appl. No.: 13/101,023

(22) Filed: May 4, 2011

(51) Int. Cl. G06Q 30/00; G06Q 50/00

(52) U.S. Cl. 705/34; 705/327

(57) ABSTRACT

Articles of manufacture, education billing management methods, education billing management systems, education enrollment systems, and education enrollment methods are described. According to one aspect, an article of manufacture includes media comprising programming which causes processing circuitry to perform processing comprising accessing expense information regarding education expenses owed to a plurality of learning providers as a result of the learning providers providing education services to a plurality of employees of a plurality of employers, for each of the employers, using the expense information, generating billing information regarding the education expenses incurred by the employees of the respective employer, communicating respective billing information to respective ones of the employers, wherein the billing information communicated to one of the employers includes the education expenses owed to at least one of the learning providers as a result of the at least one learning provider providing education services to one or more employees of the one of the employers, and determining disbursement amounts to be paid to respective ones of the learning providers, wherein one of the disbursement amounts to be paid to one of the learning providers corresponds to the education services provided by the one of the learning providers to at least one of the employees.

### TECHNICAL FIELD

This disclosure relates to articles of manufacture, education billing management methods, education billing management systems, education enrollment systems, and education enrollment methods.

### BACKGROUND OF THE DISCLOSURE

Many employers recognize advantages of having their employees continue to advance their educations after being employed. These adults may become more productive for the employers and the employees may advance to additional opportunities within the employers as the employees advance their careers through additional education.

Adult Education, also known as Continuing Education, Training, Seminars and other terms, is the practice of employed adults taking classes to improve their skills and knowledge, either in the area of their industry, or in other areas of interest. Many adult employees typically take classes to keep their skills up to date. Other adult employees may have previously decided against getting a degree in order to enter the workplace, but later find the lack of a degree or advanced degree is limiting their career options. To improve their career path, these employees may enter and complete degree programs while they are employed.

Many employers today, particularly large corporations, have tuition assistance as an employment benefit. To encourage employees to improve themselves, the employers offer full or partial payment of the costs of continuing education. This is often a substantial benefit since many degree programs can run tens of thousands of dollars per year. Different employers may implement the tuition assistance in different ways. Typically, the employer will either advance the employee an amount of money required to enroll the employee as a student to receive education services, or they will reimburse an employee after they have received the education services.

At least some aspects of the disclosure are directed towards methods, apparatus and software which facilitate management of expenses incurred by employees while obtaining additional education, billing of employers for education services, and compensating learning providers for the educational services extended to the employees.

### BRIEF DESCRIPTION OF THE DRAWINGS

Exemplary embodiments of the disclosure are described below with reference to the following accompanying drawings.

FIG. 1 is a functional block diagram of employers, a management system and learning providers according to one embodiment.

FIG. 2 is a functional block diagram of a computing system according to one embodiment.

FIG. 3 is a flow chart of a method to enroll an employee as a student with a learning provider according to one embodiment.

FIG. 4 is a flow chart of a method to manage compensation provided to the learning providers according to one embodiment.

### DETAILED DESCRIPTION OF THE DISCLOSURE

This disclosure is submitted in furtherance of the constitutional purposes of the U.S. Patent Laws “to promote the progress of science and useful arts” (Article 1, Section 8).

According to one embodiment, an article of manufacture comprising media comprising programming which causes processing circuitry to perform processing comprises accessing expense information regarding education expenses owed to a plurality of learning providers as a result of the learning providers providing education services to a plurality of employees of a plurality of employers, for each of the employers, using the expense information, generating billing information regarding the education expenses incurred by the employees of the respective employer, communicating respective billing information to respective ones of the employers, wherein the billing information communicated to one of the employers includes the education expenses owed to at least one of the learning providers as a result of the at least one learning provider providing education services to one or more employees of the one of the employers, and determining disbursement amounts to be paid to respective ones of the learning providers, wherein one of the disbursement amounts to be paid to one of the learning providers corresponds to the education services provided by the one of the learning providers to at least one of the employees.

According to an additional embodiment, an education billing management method comprises accessing expense information regarding education expenses associated with an employee of an employer receiving education services from a learning provider, using the expense information, generating billing information which is indicative of an amount owed by the employer to the learning provider to compensate the learning provider for providing the education services to the employee, communicating the billing information to the employer, receiving funds to compensate the learning provider for the education services provided by the learning provider to the employee of the employer, and disbursing funds to the learning provider to compensate the learning provider for the education services provided by the learning provider to the employee of the employer.

According to another embodiment, an education billing management system comprises processing circuitry configured to access expense information regarding education expenses associated with an employee of an employer receiving education services from a learning provider, access business rules of the employer which define which of the education expenses qualify for payment by the employer, use the business rules to process the education expenses to determine billing information which is indicative of an amount of the education expenses which qualify for payment by the employer; and communicate the billing information to the employer.

According to yet another embodiment, an education enrollment system comprises processing circuitry configured to access a payment authorization which enables an employee of an employer to enroll to receive education services from a learning provider, and wherein at least a portion of expenses of the education expenses provided by the learning provider are to be paid by the employer, generating an agreement to be accepted by the employee of the employer to permit the employee to receive the education services from the learning provider, and as a result of the agreement being accepted by the employee, creating an authorization code which is useable by the employee to receive the education services from the learning provider.

According to another additional embodiment, an education enrollment method comprises providing an authorization code which is useable by an employee of an employer to receive authorized education services from a learning provider which will be paid by the employer, storing enrollment information associated with the authorization code and which indicates the authorized education services which the employee is permitted to enroll for with the learning provider which will be paid by the employer, after the providing and storing, accessing a communication requesting the enrollment information, and as a result of the accessing, communicating the enrollment information to the learning provider to be used to enroll the employee as a student with the learning provider to receive the authorized education.

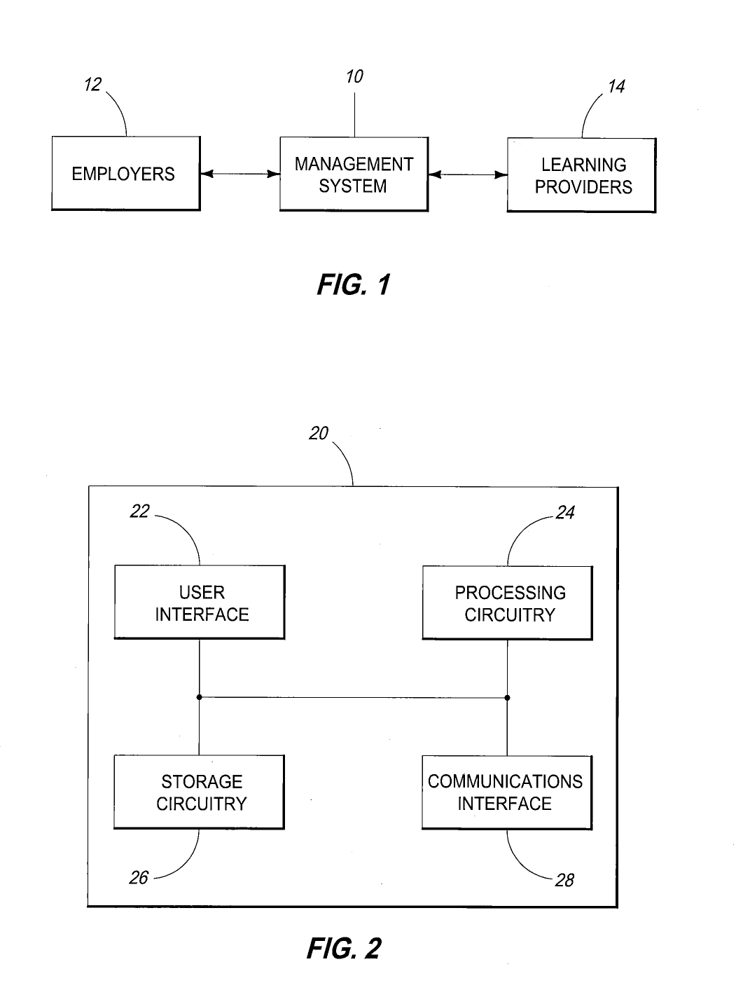

Referring to FIG. 1, a management system 10 which is configured to implement management operations between a plurality of employers 12 and learning providers 14 is shown according to one embodiment. The employers 12 and learning providers 14 may become clients of the operator of the management system 10 prior to using the services of the management system 10 described herein in one implementation.

Management system 10 is configured to access information regarding educational services provided by the learning providers 14 to employees of the employers 12. For example, employees may receive education services by attending events (e.g., courses, classes, seminars, trainings, etc.) which are provided by the learning providers 14 which may include colleges, universities, or private companies which may specialize in a particular education, such as legal education or marketing training. Many colleges and universities have set up specialized programs catering to working adults with events scheduled at night or on weekends. According to one embodiment, the management system 10 may use the accessed information to generate bills which are provided to the employers 12 for payment or reimbursement of the educational services, and to generate payment information regarding amounts to be paid to the learning providers 14 for the educational services.

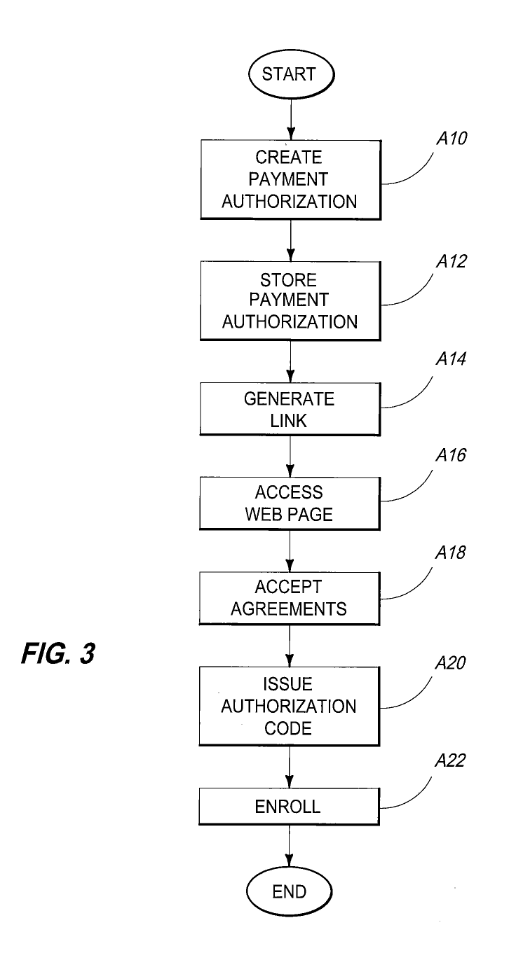

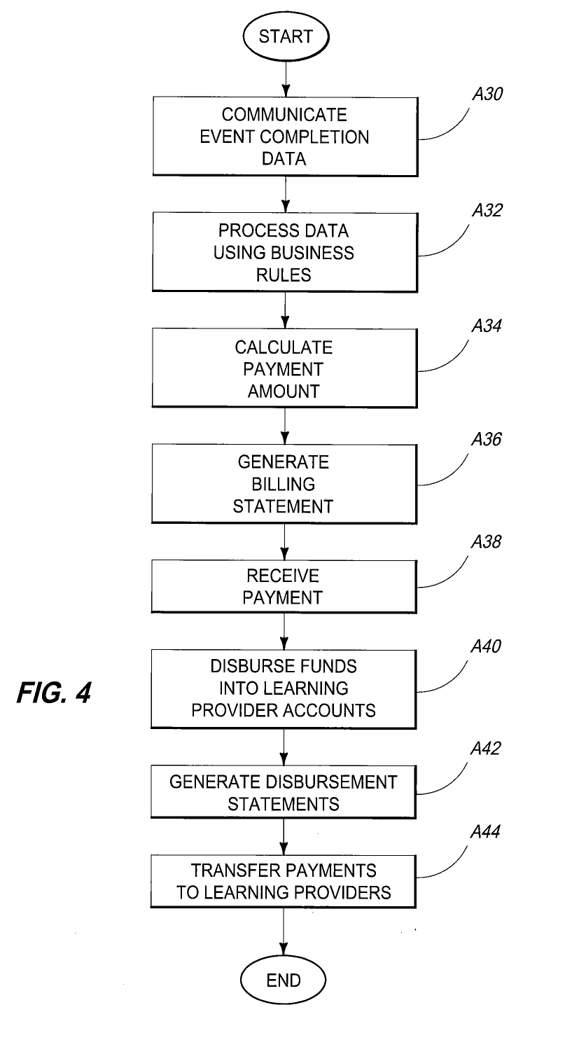

In some implementations, one or more of the management system 10, employers 12 and learning providers 14 may be implemented using a respective computing system. FIG. 2 illustrates one example computing system 20 which may be configured to implement operations of any one of the management system 10, an employer 12 or a learning provider 14. In one implementation, each of the management system 10, employers 12 and learning providers 14 utilize at least one computing system 20 to perform one or more of the operations described herein. For example, the computing systems 20 may be arranged to implement the methods described below with respect to FIGS. 3 and 4 in one embodiment.

In the example depicted embodiment, computing system 20 includes a user interface 22, processing circuitry 24, storage circuitry 26 and communications circuitry 28. Other configurations of computing system 20 are possible including more, less and/or alternative components.

User interface 22 is configured to interact with a user including conveying data to a user (e.g., displaying visual images for observation by the user) as well as receiving inputs from the user. User interface 22 is configured as a graphical user interface (GUI) in one embodiment. User interface 22 may be configured differently in other embodiments.

In one embodiment, processing circuitry 24 is arranged to process data, control data access and storage, issue commands, and control other desired operations. Processing circuitry 24 may comprise circuitry configured to implement desired programming provided by appropriate computer-readable storage media in at least one embodiment. For example, the processing circuitry 24 may be implemented as one or more processor(s) and/or other structure configured to execute executable instructions including, for example, software and/or firmware instructions. Other exemplary embodiments of processing circuitry 24 include hardware logic, PGA, FPGA, ASIC, state machines, and/or other structures alone or in combination with one or more processor(s). These examples of processing circuitry 24 are for illustration and other configurations are possible.

Storage circuitry 26 is configured to store programming such as executable code or instructions (e.g., software and/or firmware), electronic data, databases, image data, or other digital information and may include computer-readable storage media. At least some embodiments or aspects described herein may be implemented using programming stored within one or more computer-readable storage medium of storage circuitry 26 and configured to control appropriate processing circuitry 24.

The computer-readable storage medium may be embodied in one or more articles of manufacture which can contain, store, or maintain programming, data and/or digital information for use by or in connection with an instruction execution system including processing circuitry 24 in the exemplary embodiment. For example, exemplary computer-readable storage media may be non-transitory and include any one of physical media such as electronic, magnetic, optical, electromagnetic, infrared or semiconductor media. Some more specific examples of computer-readable storage media include, but are not limited to, a portable magnetic computer diskette, such as a floppy diskette, a zip disk, a hard drive, random access memory, read only memory, flash memory, cache memory, and/or other configurations capable of storing programming, data, or other digital information.

In one embodiment, the storage circuitry 26 may store information regarding the employers, learning providers and education services for employees of the employers. For example, the storage circuitry 26 may store a plurality of accounts for the employers and the learning providers. The accounts of the employers may include amounts owed by the employers to be paid to the learning providers for educating the employees of the employers and the accounts of the learning providers may include amounts owed to the learning providers by the employers for providing the education services. Additional information may be stored as described in example embodiments below.

Communications circuitry 28 is arranged to implement communications of computing system 10 with respect to external devices (not shown). For example, communications interface 28 may be arranged to communicate information bi-directionally with respect to computing system 20. Communications interface 28 may be implemented as a network interface card (NIC), serial or parallel connection, USB port, Firewire interface, flash memory interface, or any other suitable arrangement for implementing communications with respect to computing system 20.

In one implementation, the computing systems 20 of the management system 10, employers 12 and learning providers 14 are arranged to communicate with one another via the internet. Users may access the computing systems 20 via web pages in one embodiment. In one embodiment, the computing system 20 of an employer 12 may be used to implement various operations discussed herein, such as implementing a procurement system of the employer or a communication interface to a procurement system of the employer, submitting business rules and payment authorizations to the management system 10, receiving billing information regarding education services provided to employees, and providing payment to the learning providers. A computing system 20 of learning provider 14 may be used to enroll employees in events, receive authorization codes from employees, receive enrollment information from the management system, submit expense information for educating the employees, and receiving payment for the education services.

Referring to FIG. 3, one example method is illustrated for enrolling an employee to receive education services from a learning provider. One or more of the acts of the illustrated method may be implemented using computing systems 20 of the management system 10, employers 12 and learning providers 14 in one embodiment. Other methods are possible including more, less and/or alternative acts.

At an act A10, a payment authorization may be created by the employer to allow an employee to enroll and receive education services under a tuition assistance policy of the employer. The tuition assistance policy may specify what education the employer will pay for and under what conditions. For example, the tuition assistance policy may specify types of events (e.g., courses) or degrees which qualify under the policy, limits on total costs, specified minimum grade requirements, approved learning providers, limits on fees, etc.

More specifically, in one embodiment, an employee who is seeking to receive educational services may submit a plan to an education administrator of the employer for approval. The education administrator may be responsible for assisting employees of the employer with obtaining continuing education. The education administrator may evaluate the plan and determine whether it fits within the tuition assistance policy of the employer. If the employee's request is approved, then the education administrator of the company (or other responsible individual) may access a web page which is served by the computing system of the management system to create a payment authorization within the management system in one embodiment. The payment authorization may be subsequently activated to provide a purchase authorization and authorization code which may be used by an employee to enroll with a learning provider to receive continuing education in one embodiment.

In one embodiment, the payment authorization includes details which facilitate management of the continuing education by the employer 12. For example, the payment authorization may include the following information: a company tracking code (e.g., unique identifier supplied by the employer or referenced to a procurement system of the employer which may internally track the purchase within the employer), tuition amount to be paid by the employer, expiration date, event information (e.g., event number which references a particular class or course provided by a learning provider, event title or other description of the event provided by the learning provider, event fee types, and event fee amounts), and custom information supplied by the employer which may be returned back to the employer when referencing the authorization information and which may assist with tracking of the purchasing of the events.

The payment authorization may be created in a database of the computing system of the management system by manually entering it in a web-based data entry form served by the management system or via an electronic message from a procurement system of the employer, tuition assistance tracking software, or by a web-based service company in illustrative examples. In one configuration for implementing electronic communication, the computing systems of the employers are configured to communicate with the computing system of the management system using a documented message format of the management system.

As mentioned above, an employer may use an internal procurement system (e.g., Ariba, Concur) or other software for tracking purchases within their organization. For example, these systems may track the purchases, who authorized the purchases, amounts of purchases, and purposes of the purchases. In one embodiment, the management system is arranged to receive payment authorizations from the employers' procurement systems and to communicate billing information to the employer's procurement systems.

At an act A12, the created payment authorization may be stored within a database of the computing system of the management system. The stored payment authorization enables the management system to track the events the employee is authorized to take and the expenses the employer will pay for. In one embodiment, the created payment authorization is not activated until subsequent conditions have been met, such as the employee agreeing to various agreements as discussed further below in one example. Upon activation, a purchase authorization and authorization code are generated and which may be used by the employee to enroll to receive the education services as discussed below.

At an act A14, the management system generates an activation link which is associated with the payment authorization and may be utilized by the employee to activate the payment authorization which is stored in the database. In one embodiment, the payment authorization is activated prior to use by the employee to enrollment in events to receive the education services. The activation link may be a unique URL in one embodiment which is communicated to the employer and which may be forwarded to the employee for use, for example, by sending the activation link by email to the employee, using a feature of the employer's procurement system, or via other internal process utilized by the employer to send the link to the employee.

At an act A16, the employee utilizes the activation link to access a web page of the computing system of the management system which corresponds to the stored payment authorization and education services to be provided to the employee.

At an act A18, the web page served by the management system includes terms which are accepted by the employee for activation of the payment authorization and issuance of the purchase authorization and an authorization code to enable the employee to enroll to attend one or more events of a learning provider to receive the educational services which will be at least partially compensated for by the employer. The employee is not issued purchase authorization or authorization code to enroll with the learning provider to receive the education services through the tuition assistance policy of the employer unless they accept the terms provided by the stored payment authorization in one embodiment.

In one embodiment, the terms to be accepted may include one or more agreements which are to be accepted by the employee to be entitled to be enrolled in the events of the learning provider. Example agreements include a Family Educational Rights and Privacy Act (FERPA) agreement to authorize the learning provider(s) to release grades or other private information as required to the management system and employer for purposes of tuition assistance; an agreement as to the terms of payment if the employer chooses not to pay for the services (e.g., this agreement may inform the student that the student is ultimately responsible for the charges from the learning provider should the student not meet the requirements for payment or the employer chooses to not pay for the education services received by the employee for any reason) and any other agreements required by the employer or learning provider. For example, learning providers may provide their own respective agreements which include terms which are accepted before the employee may be enrolled to receive education services from the respective learning providers.

As discussed above, the employee may be required to obtain a given grade in order for the employer to pay for the education services. For example, the employers may provide company business rules as discussed in further detail herein which specify the requirements for payment of education expenses. Companies may work with representatives of the management system to generate the business rules, communicate the business rules to the management system, or input the business rules into the management system using a user interface supported by the management system in example embodiments. An employer may modify its business rules at different points in time to meet its needs.

As mentioned previously, the payment authorization is not activated and the employee is not issued a purchase authorization and an authorization code if the employee does not accept the terms of the payment authorization in one embodiment. If the employee desires to accept the terms and to receive the authorization code, the employee may be required to enter information which constitutes a legal digital signature in one embodiment. Example digital signatures may include the name of the employee, the name of the employee plus the last four digits of their social security number, or any other valid digital signature.

At an act A20, following the entry of their digital signature and agreeing to all applicable terms of the payment authorization (e.g., agreeing to any applicable agreements), the management system activates the payment authorization and creates the purchase authorization and a unique authorization code which is provided to the employee and which enables the employee to enroll with a learning provider, and the employer will pay for the education services provided by the learning provider if the terms of the tuition assistance policy of the employer are met.

The authorization code may be shown to the employee on the web page served by the management system, emailed to the employee, printed by the employee, recorded by the procurement system of the employer and forwarded to the employee, sent to the employer by a third party administrator and released to the employee, or in any other suitable manner.

At an act A22, the employee may utilize the authorization code to enroll with a learning provider. The authorization code may be used by the employee to guarantee payment of events from the employer (as well as the employee or other source) to the appropriate learning provider. The employee may provide the authorization code to the learning provider in a variety of suitable methods, for example, including entering the authorization code into an enrollment web site of the learning provider, presenting the authorization code in person to the learning provider's enrollment staff or utilizing phone-based enrollment.

For enrollment via the web, the employee may access a web site of the learning provider which is used for enrollment in events or other services of the learning provider. The web site accepts the authorization code which was issued by the management system from the employee and the computing system of the learning provider may thereafter implement secured communications with the computing system of the management system to receive a list of events in which the employee is authorized to enroll in under the tuition assistance policy of the employer. The learning provider may communicate the list of events for possible enrollment to the employee along with any other information pertinent to enrollment with the learning provider. For example, the learning provider may request selection of the time for taking the event, select a physical location for taking the event, optional attributes for the events, or other desired information.

In another embodiment, the employee may present a certificate which includes the authorization code to the learning provider in person or via the telephone, and the learning provider may thereafter communicate with the management system to enroll the employee as discussed above.

The management system may facilitate the enrollment process of the student to receive the education services from the learning provider in one embodiment. For example, details of the education expenses which are approved under the tuition assistance policy for the respective authorization code for the student may be stored with the management entity. The computing system of the learning provider may access the computing system of the management system through an appropriate web page using an access login code and password associated with an account of the learning provider with the management system.

As mentioned above, the authorization code provided by the employee may be communicated to the management system by the learning provider during an enrollment process of the employee. For example, the learning provider may access a web page of the management system and submit the authorization code provided by the employee. The management system may store enrollment information associated with the approved authorization code and which indicates the education services the employee is entitled to enroll in and receive payment for by the employer under the employer's tuition assistance policy. For example, the enrollment information may include tuition amounts, expiration dates, event information of approved events (event number of the learning provider, event title, event fee types, and event fee amounts).

After receipt of the authorization code from the learning provider during the enrollment process, the management entity may communicate the enrollment information associated with the respective authorization code to the learning provider. The learning provider and employee may review the details of the enrollment information associated with the authorization code during the enrollment process and the employee may be enrolled to receive the education services of the learning provider for approved event(s) specified by the enrollment information in one embodiment.

After enrollment with the learning provider, the employee attends the event(s) which may be days or months of education services provided by the learning provider. The events provided by the learning providers may have ending dates when the employees have completed the events. The learning providers may assign grades which are judgments of how the employee performed in the events. In one embodiment, the learning providers may communicate the grades to the management system. As discussed below, the grades may be utilized to determine whether the employee complies with company business rules of the employer and the education services are entitled for payment in accordance with the tuition assistance policy of the employer.

Referring to FIG. 4, one example method for compensating learning providers for educating the employees is shown. One or more of the acts of the illustrated method may be implemented using computing systems 20 of the management system 10, employers 12 and learning providers 14. Other methods are possible including more, less and/or alternative acts.

At an act A30, the learning provider communicates data regarding the completion of event(s) by an employee to the management system. In one embodiment, the learning provider may directly access a website of the management entity and submit the event completion data. The event completion data may include an acknowledgement of event completion, grade for the event(s) (which may be released without penalty if the employee has executed an appropriate FERPA agreement discussed above), expense information including details of the costs and fees for the event, and the student/employee's name as well as any other identification information useable by the employer for auditing purposes to be sure that the employee of the employer attended and completed the events to reduce the chances that another person may have fraudulently attended the events.

In one embodiment, the learning provider may access a web site of the management system using a sign-in code and password and communicate the event completion data regarding the completion of the events by the employee. In another embodiment, the computing system of the learning provider may be programmed to upload the event completion data regarding the completion of the event automatically upon completion of the events by the employee.

At an act A32, the management system may access the appropriate company business rules for the employer of the employee who completed the events for processing the event completion data and to determine which education expenses qualify for payment by the employer according to the tuition assistance policy of the employer.

For example, the expense information regarding all costs and fees associated with the employee's attending the event(s) is processed using the company business rules of the employer in accordance with the tuition assistance policy of the employer. Example company business rules may be provided according to the tuition assistance policy of the employer and specify the maximum tuition for an event which will be paid by the employer, a specified minimum grade level for the event to qualify for payment by the employer, fee types which are paid for or not paid for (e.g., the employer may pay for parking fees but not student health fees, etc.), and appropriate types of materials (e.g., books, science lab supplies, project materials, etc.) which are paid for or not paid for. For example, payment for an event may depend upon the employee meeting a minimum grade required by the business rules. Additionally, the business rules may specify that some fees are appropriate for payment while others are not.

At an act A34, the management system calculates a payment amount which is to be paid from the employer to the learning provider. The payment amount may be determined by the processing of the event completion data using the company business rules to determine the appropriate payment amount which is to be paid by the employer pursuant to the tuition assistance policy of the employer.

The payment amount for the completed event may be entered into an accounting database of the management system as a charge to the employer of the employee and a payment to the learning provider who provided the education services to the employee. Other appropriate information may also be stored with the payment information including description information including the student's name, event description, event grade, actual cost amount before application of the company business rules, breakdown of fees within the payment amount, and any other information desired by the employer or learning provider. The management system may also store an auditable and traceable log of the specific company business rules which were utilized to calculate the payment amount.

At an act A36, the management system generates billing information which includes the payment amount which is owed to the learning provider who provided the education services during the event to the employee. The billing information may be communicated as a billing statement which includes the payment amount based upon the business rules plus additional information, such as the student's name, learning provider name, learning provider identifier (e.g., a string of letters or digits uniquely identifying the learning provider), an employer tracking code (for example which allows the line item to be tracked against the employer procurement system), event identifier used by the learning provider (e.g., catalog number), event description, tuition amount, reason for the payment amount being full payment, non-payment, or lesser payment based on the company business rules, fee information (type of fees, amounts of fees, amount to be paid based on company business rules, reason for payment based on the company business rules), custom information sent by the employer in the purchase authorization, and any credits or debits to correct prior entries. For example, a billing statement may be produced with incorrect information, such as by data entry errors, or an employer may decide to pay for an event after an initial rejection. Accordingly, a credit or debit may be applied in a later statement to bring the charges and payments into balance.

In some implementations, a billing statement may include billing information for one event attended by a single employee at a single learning provider. In other embodiments, a billing statement may be generated for an employer which includes billing information for a plurality of events attended by one or more employees of the respective employer at one or more learning provider. For example, the employer may specify its billing cycle, and the management system may provide a billing statement at the end of the billing cycle which includes billing information of all the events attended by the employees of the employer since the last billing statement. The billing statement may include an aggregate total of the payment amounts for the employer to pay and which reflects all charges incurred by all employees across all learning providers for the billing period in one embodiment.

The billing statement is communicated to the employer (e.g., via mail, email, to the computing system of the employer, etc.) and may also be stored within a statement database of the management system and as a payment entry within an accounting database of the management system in one embodiment. The billing statement may be accessed from the management system by authorized personnel of the management system or the employer, for example, via a web site hosted by the management system and using an access sign-in code and password.

Some portions of the education expense information may not qualify for payment by the learning provider after the application of the business rules (e.g., if the employee fails to meet a required minimum grade). In one embodiment, the management system removes the non-qualifying portion of the expense information from the payment amount which the employer owes. In one embodiment, the management system may communicate the amount of the expense information which does not qualify for payment by the employer to the learning provider who may seek payment from the student, perhaps pursuant to an agreement signed by the employee at act A18 discussed above.

At an act A38, the employer makes a payment to the management system after receipt of the billing statement. The payment typically includes the full amount of the billing statement although other billing arrangements, such as partial payments, may be accepted depending upon terms negotiated between the management system and the employer. The payment from the employer to the management system may be made in different ways, for example, the employer may electronically transfer funds from their bank account to a bank account of the management system, the employer may mail a standard bank check, the employer may authorize the management system to transfer funds where the management system initiates an electronic transfer of funds from the employer's bank account to a bank account of the management system, or the management system may charge a payment card (e.g., debit or credit card of the employer).

Upon receipt of the funds by the management system, the employer's account in the accounting database of the management system may be credited and the billing statement in the statement database of the management system may be marked as paid.

At an act A40, the management system, upon receipt of a payment from the employer, may match the payment with events on the billing statement. For each learning provider on the billing statement for which the payment was made, the management system may allot funds of the payment into disbursement accounts for the learning providers in the accounting database of the management system. In one embodiment, the disbursement accounts include funds which are ready to be paid to learning providers for events which have already been completed by employees of the participating employers.

Other embodiments are possible. For example, the management system may make a short-term loan to a learning provider by placing funds into the disbursement account for a learning provider in anticipation of payment by an employer and prior to receipt of the payment by the employer.

At an act A42, the management system generates disbursement statements for each of the learning providers. The disbursement statements may include disbursement amounts which are ready to be paid out to the learning providers based upon the completion of events, and either receipt of funds from the employers or based upon loans of the management system to the learning providers in anticipation of payment by one or more employers. The disbursement statements may be generated at ends of the payment cycles for the learning providers. In one embodiment, the disbursement statements may include detailed line items regarding the events which have been approved for payment through the management system.

For example, the disbursement statements may include the student's name which attended an event, the employer name, employer identifier (e.g., a string of letters or digits uniquely identifying the employer), payment authorization identifier originally used when enrolling the employee in an event, event identifier used by the learning provider (e.g., catalog number), event description, tuition amount, disbursement amount to be paid based upon the company business rules, reason for the payment amount being full payment, non-payment, or lesser payment based on the company business rules, fee information (type of fees, amounts of fees, amount to be paid based on company business rules, reason for payment based on the company business rules), custom information sent by the employer in the purchase authorization, and any credits or debits to correct prior entries.

In some implementations, the disbursement amount of a disbursement statement may include the payment amount for one event attended by a single employee at the learning provider. In other embodiments, the disbursement amount may be generated for a learning provider which includes payment amounts for a plurality of events attended by one or more employees of one or more employer at the learning provider. For example, the learning provider may specify its payment cycle, and the management system may provide the disbursement statement at the end of the payment cycle which includes the disbursement amount which includes the payment amounts of all the events attended by the employees of the employers since the last payment statement. The disbursement amount may include an aggregate total of the payment amounts paid to the learning provider and which reflects all charges incurred by employees across all employers for the payment period in one embodiment.

At an act A44, the management system transfers payments to the learning providers according to the respective disbursement amounts of the learning providers. In one embodiment, a payment for one of the learning providers may pay for all of the respective events performed by the learning provider since the last payment cycle.

The payment may be made in different ways, such as, the management system electronically transferring funds from an account of the management system to a bank account of the learning provider, mailing a standard bank check to the learning provider, the management system transferring funds to a bank debit card account of the learning provider, or the management system transferring funds to a cash holding/payment service, such as PayPal.

In other embodiments, the management system does not receive funds from the employers to be paid to the learning providers nor does the management system make payments to the learning providers. For example, the employers may pay the learning providers directly based upon the billing information generated by the management system.

As mentioned above according to one example embodiment, the amount paid by the management system may be less than the amount owed by the employee to the learning provider depending upon the company business rules. In one implementation, the learning provider may be responsible to collect the difference owed by the employee to the learning provider. For example, as mentioned above, one of the agreements signed by the employee may be an agreement for the employee to pay the learning provider directly in the case that the total cost of the events attended by the employee was not paid by the employer. The management system may notify the learning providers of the amounts not paid by the employers and which need to be collected from the employees.

The above-described methods are example methods to illustrate some implementations of the present disclosure. Other methods are possible in other implementations or embodiments. For example, the management system may implement various operations discussed herein, such as management of events attended by employees, management of billing and payments of the employers, and management of disbursements to the learning providers without receiving funds from employers for payment to learning providers, or disbursing funds to learning providers in one other example embodiment as discussed above. In embodiments where the management system does not receive funds for payment to learning providers, the management system may maintain accounting information of billing information communicated to the employers, payments made to learning providers and amounts still owing to the learning providers.

In some embodiments, the management system receives compensation from the employers and/or the learning providers in exchange for the management services provided by the management system. For example, the employers and/or learning providers may pay flat fees to operators of the management system, or pay fees depending upon a numbers of transactions managed by the management system in some examples. In one embodiment, the operator of the management system may subtract any service fees owed for the management services from the disbursement amounts paid to the learning providers as compensation. Furthermore, the operator of the management system may add services fees to the payment amount which is billed to employers as compensation for the management services in another embodiment.

In one embodiment, the management system utilizes standardized codes for use with different fee codes of employers and learning providers. For example, the management entity may specify a master list of fee codes which correspond to all of the different fees which may be charged by a learning provider. The employers' fee codes and learning providers' fee codes may be mapped to the standardized fee codes of the management system (e.g., a university enrollment fee may be mapped to a registration fee in the master list). Upon receipt of a payment authorization, the employer's fee codes and authorized dollar amounts within the payment authorization may be mapped to the standardized fee codes (or fee codes of the learning provider) and provided into a purchase authorization to enroll the employee with the learning provider. Upon completion of education services, the learning provider may access a website of the management system, and enter the standardized fee codes (or its own fees codes) and the respective amounts of the fees. The management system may translate the entered fee codes into fee codes of the employer for communication in the billing information with the fee amounts in one embodiment.

The methods and systems of the present disclosure may provide benefits to both employers and learning providers. For example, the management system may manage the expense information for numerous employees of a single employer enabling the employer to reduce its resources to implement its tuition assistance policy while also reducing administrative burdens by participating learning providers.

Furthermore, some governments may provide certain financial grants to students who show financial need. The grants are normally made directly to the school. Furthermore, the government may provide certain need-based and non-need based loans to help students finance their educations. More recently, some governments have moved to remove banks from these loans and become direct lenders of the loans themselves. However, students may default on the government loans and some governments have or may impose requirements that, in order for the learning provider to be included in the government loan program, they must be able to prove that 10% of their revenues come from sources other than government financial aid. A learning provider's ratio of revenue from government sources and non-government sources may be improved using systems and methods of the present disclosure since the employers may be directly billed by the learning provider thereby increasing the portion of revenue of the learning provider which results from a source other than government financial aid.

According to some embodiments herein, methods and systems are described to implement direct billing operations for educational services extended to an employee of a company which provides tuition assistance without involving the employee in the financial transaction. In one embodiment, the employers which provide tuition assistance may become clients of the management system and subscribing learning providers may also become clients of the management system. The management system manages an example direct billing process where the learning providers provide expense information to the management system, which in turn bills the employers, and the employers forward funds to the management system, which in turn makes payments to the learning providers in one example embodiment.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

What is claimed is:

1. An article of manufacture comprising:
media comprising programming which causes processing circuitry to perform processing comprising:
accessing expense information regarding education expenses owed to a plurality of learning providers as a result of the learning providers providing education services to a plurality of employees of a plurality of employers;
for each of the employers, using the expense information, generating billing information regarding the education expenses incurred by the employees of the respective employer;
communicating respective billing information to respective ones of the employers, wherein the billing information communicated to one of the employers includes the education expenses owed to at least one of the learning providers as a result of the at least one learning provider providing education services to one or more employees of the one of the employers; and
determining disbursement amounts to be paid to respective ones of the learning providers, wherein one of the disbursement amounts to be paid to one of the learning providers corresponds to the education services provided by the one of the learning providers to at least one of the employees.

2. The article of claim 1 wherein the programming further causes the processing circuitry to perform processing comprising accessing business rules of at least one of the employers which define which education expenses qualify for payment by the at least one employer, and wherein the generating billing information for the at least one of the employers comprises processing the education expenses owed to at least one of the learning providers as a result of the at least one learning provider providing education services to at least one employee of the at least one employer with respect to the business rules of the at least one employer to determine an amount of the education expenses which qualify for payment by the at least one employer.

3. The article of claim 1 wherein the programming further causes the processing circuitry to perform processing comprising maintaining a plurality of accounts for the employers and the learning providers, wherein the accounts of the employers include amounts owed by the employers to be paid to the learning providers and the accounts of the learning providers include amounts owed to the learning providers by the employers.

4. The article of claim 1 wherein the programming further causes the processing circuitry to perform processing comprising controlling disbursement of funds to the learning providers according to the disbursement amounts.

5. An education billing management method comprising:
accessing expense information regarding education expenses associated with an employee of an employer receiving education services from a learning provider;
using the expense information, generating billing information which is indicative of an amount owed by the employer to the learning provider to compensate the learning provider for providing the education services to the employee;
communicating the billing information to the employer;
receiving funds to compensate the learning provider for the education services provided by the learning provider to the employee of the employer; and
disbursing funds to the learning provider to compensate the learning provider for the education services provided by the learning provider to the employee of the employer.

6. The method of claim 5 further comprising:
receiving a payment authorization from the employer which enables the employee of the employer to enroll to receive the education services from the learning provider; and
presenting an agreement to be accepted by the employee of the employer as a condition for the employee to receive the education services from the learning provider.

7. The method of claim 6 further comprising creating an authorization code which is useable by the employee to receive the education services from the learning provider as a result of the employee accepting the agreement which permits the learning provider to release a grade obtained by the employee from the learning provider.

8. The method of claim 5 further comprising accessing business rules of the employer which define which of the education expenses qualify for payment by the employer, and wherein the generating comprises processing the expense information using the business rules to determine the billing information which is indicative of an amount of the education expenses which qualify for payment by the employer.

9. The method of claim 8 wherein the processing comprises determining that a portion of the education expenses do not qualify for payment from the employer and the amount of the education expenses which qualify for the payment by the employer does not include the non-qualifying portion of the education expenses.

10. The method of claim 9 further comprising notifying the learning provider of the non-qualifying portion of the education expenses.

11. The method of claim 5 wherein the expense information is first expense information, the learning provider is a first learning provider, the employee is a first employee, and the billing information is first billing information and further comprising:
receiving second expense information regarding education expenses associated with a second employee of the employer receiving education services from a second learning provider;
using the second expense information, generating second billing information which is indicative of an amount owed by the employer to the second learning provider to compensate the second learning provider for providing respective education services to the second employee;
communicating the second billing information to the employer;
receiving funds to compensate the second learning provider for the education services provided by the second learning provider to the second employee; and
disbursing funds to the second learning provider to compensate the second learning provider for the education services provided by the second learning provider to the second employee.

12. The method of claim 5 wherein the expense information is first expense information, the employee is a first employee, the employer is a first employer, and the billing information is first billing information, and further comprising:
receiving second expense information regarding education expenses associated with a second employee of a second employer receiving education services from the learning provider;
using the second expense information, generating second billing information which is indicative of an amount owed by the second employer to the learning provider to compensate the learning provider for providing respective education services to the second employee;
communicating the second billing information to the second employer;
receiving funds to compensate the learning provider for the second education expenses; and
wherein the disbursing comprises disbursing funds to the learning provider to compensate the learning provider for the education services provided by the learning provider to the second employee.

13. An education billing management system comprising:
processing circuitry configured to:
access expense information regarding education expenses associated with an employee of an employer receiving education services from a learning provider;
access business rules of the employer which define which of the education expenses qualify for payment by the employer;
use the business rules to process the education expenses to determine billing information which is indicative of an amount of the education expenses which qualify for payment by the employer; and
communicate the billing information to the employer.

14. The system of claim 13 wherein the processing circuitry is configured to determine that a portion of the education expenses do not qualify for payment from the employer and to exclude the non-qualifying portion of the education expenses from the billing information.

15. The system of claim 14 wherein the processing circuitry is configured to notify the learning provider of the non-qualifying portion of the expenses.

16. The system of claim 14 wherein the business rules require that the employee obtain a specified grade for the education services from the learning provider, and the non-qualifying portion corresponds to an amount of the education expenses associated with the education services in which the employee failed to obtain the specified grade.

17. The system of claim 16 further comprising a communications interface configured to receive the grade obtained by the employee for the education services from the learning provider.

18. The system of claim 14 wherein the business rules define which types of fees of the education expenses are acceptable for payment from the employer, and the non-qualifying portion corresponds to an amount of the education expenses associated with at least one fee which is not acceptable for payment from the employer.

19. The system of claim 13 further comprising a communications interface configured to receive a grade obtained by the employee for the education services from the learning provider, and the processing circuitry is configured to use the business rules to process the grade to determine the billing information.

20. An education enrollment system comprising:
processing circuitry configured to:
access a payment authorization which enables an employee of an employer to enroll to receive education services from a learning provider, and wherein at least a portion of expenses of the education expenses provided by the learning provider are to be paid by the employer;
generate an agreement to be accepted by the employee of the employer to permit the employee to receive the education services from the learning provider; and
as a result of the agreement being accepted by the employee, create an authorization code which is useable by the employee to receive the education services from the learning provider.

21. The system of claim 20 wherein the agreement permits the learning provider to release grades of the employee to at least one party besides the employee.

22. The system of claim 20 wherein the agreement requires that the employee will be responsible for education expenses which are not paid for by the employer.

23. An education enrollment method comprising:
providing an authorization code which is useable by an employee of an employer to receive authorized education services from a learning provider which will be paid by the employer;
storing enrollment information associated with the authorization code and which indicates the authorized education services which the employee is permitted to enroll for with the learning provider which will be paid by the employer;
after the providing and storing, accessing a communication requesting the enrollment information; and
as a result of the accessing, communicating the enrollment information to the learning provider to be used to enroll the employee as a student with the learning provider to receive the authorized education services.

24. The method of claim 23 wherein the communicating comprises communicating the enrollment information including at least one event the employee is authorized to receive from the learning provider.

25. The method of claim 23 wherein the accessing the communication comprises accessing using processing circuitry, and further comprising controlling the communicating of the enrollment information using the processing circuitry.
